(19) United States
(12) Patent Application Publication
(10) Pub. No.: US 2020/0044237 A1
(43) Pub. Date: Feb. 6, 2020

(54) ELECTROCHEMICAL DEVICE

(71) Applicant: Panasonic Intellectual Property Management Co., Ltd., Osaka (JP)

(72) Inventors: TAKUMI YAMAGUCHI, Kyoto (JP); NAO MATSUMURA, Osaka (JP)

(21) Appl. No.: 16/466,318

(22) PCT Filed: Dec. 26, 2017
(86) PCT No.: PCT/JP2017/046583

§ 371 Date: Jun. 4, 2019

(30) Foreign Application Priority Data
Dec. 28, 2016 (JP) 2016-255503

(51) Int. Cl. H01M 4/137; H01M 4/66; H01M 4/62; H01M 4/60; H01M 4/1399; H01M 4/04; H01G 11/52; H01G 11/28; H01G 11/48; H01G 11/68; H01G 11/86; H01G 11/06; H01G 11/50

(52) U.S. Cl. CPC H01M 4/137; H01M 4/661; H01M 4/625; H01M 4/602; H01M 4/1399; H01M 4/0404; H01M 2004/028; H01G 11/28; H01G 11/48; H01G 11/68; H01G 11/86; H01G 11/06; H01G 11/50; H01G 11/52

(57) ABSTRACT

An electrochemical device includes a positive electrode, a negative electrode, and a separator disposed between the positive electrode and the negative electrode. The positive electrode includes a positive current collector, a carbon layer, and an active layer. The carbon layer is disposed on the positive current collector and includes a conductive carbon material. The active layer is disposed on the carbon layer and includes a conductive polymer. The carbon layer includes a polyolefin resin. The positive current collector preferably includes aluminum.

### TECHNICAL FIELD

The present invention relates to an electrochemical device that includes an active layer containing a conductive polymer.

### BACKGROUND

In recent years, attention has been paid to an electrochemical device having performances intermediate between a lithium ion secondary battery and an electric double layer capacitor. Investigations have been made, for example, about use of a conductive polymer as a positive electrode material (see PTL 1). Since electrochemical devices containing, as a positive electrode material, a conductive polymer are charged and discharged by adsorption of anions (doping) and desorption of the anions (dedoping), these devices are small in reaction resistance. Thus, the electrochemical devices have a higher power than general lithium ion secondary batteries.

### CITATION LIST

### Patent Literature

PTL 1: Unexamined Japanese Patent Publication No. 2014-35836

### SUMMARY

There are a variety of methods for charging and discharging electrochemical devices. For example, in float charging, a constant voltage is continuously applied to an electrochemical device. In the case of using a positive electrode in which an active layer containing a conductive polymer is disposed on a positive current collector, capacitance of the electrochemical device becomes smaller as a charged period becomes longer. Thus, float property of the electrochemical device become degraded.

In view of the above, an aspect of the present invention relates to an electrochemical device including: a positive electrode; a negative electrode; and a separator disposed between the positive electrode and the negative electrode. The positive electrode includes: a positive current collector, a carbon layer, and an active layer. The carbon layer is disposed on the positive current collector and includes a conductive carbon material. The active layer is disposed on the carbon layer and includes a conductive polymer. And the carbon layer includes a polyolefin resin.

Another aspect of the present invention is a method for producing an electrochemical device including a positive electrode, a negative electrode, and a separator disposed between the positive electrode and the negative electrode. This method relates to a method for producing an electrochemical device. The method includes: forming a carbon layer by applying a carbon paste containing a polyolefin resin onto a positive current collector to form a coating film, and then drying the coating film; forming an active layer including a conductive polymer onto the carbon layer to yield the positive electrode; and stacking the positive electrode, the separator, and the negative electrode. The forming of the active layer is performed in an acidic atmosphere.

According to the present invention, degradation of float property of an electrochemical device can be suppressed.

### BRIEF DESCRIPTION OF THE DRAWINGS

FIG. 1 is a schematic sectional view illustrating a positive electrode according to one exemplary embodiment of the present invention.

FIG. 2 is a schematic sectional view illustrating an electrochemical device according to one exemplary embodiment of the present invention.

FIG. 3 is a schematic view for illustrating a structure of an electrode group according to the exemplary embodiment.

### DESCRIPTION OF EMBODIMENT

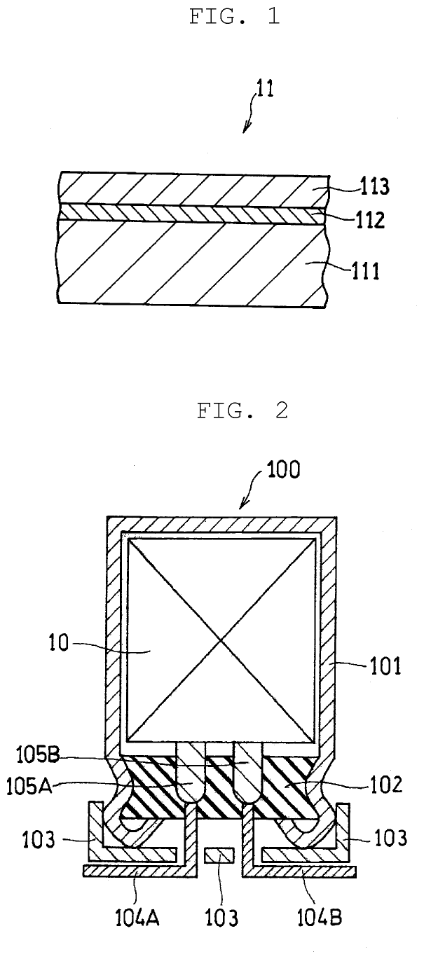

An electrochemical device according to the present exemplary embodiment includes an electrode group that includes a positive electrode, a negative electrode, a separator disposed between these electrodes. For example, as illustrated in FIG. 1, the positive electrode includes positive current collector 111, carbon layer 112 disposed on positive current collector 111, and active layer 113 disposed on carbon layer 112. Carbon layer 112 includes a polyolefin resin together with a conductive carbon material. Active layer 113 includes a conductive polymer.

Positive current collector 111 is constituted by, for example, a metallic material. A naturally oxidized film is easily formed on a surface of the collector. Thus, in order to decrease resistance between positive current collector 111 and active layer 113, carbon layer 112 containing the conductive carbon material is formed on positive current collector 111. Carbon layer 112 is formed, for example, by applying a carbon paste containing the conductive carbon material onto a surface of positive current collector 111 to form a coating film, and then drying the coating film. The carbon paste is, for example, a mixture of the conductive carbon material, a polymer material, and water or an organic solvent.

Usually, the polymer material contained in the carbon paste may be, for example, an electrochemically stable polymer, for example, a fluorine resin, an acrylic resin, polyvinyl alcohol, synthetic rubber (for example, styrene-butadiene rubber (SBR)), water glass (polymer of sodium silicate), or imide resin. However, in the case of applying, to an electrochemical device, a positive electrode having a carbon layer produced by using such a polymer material, float property of the electrochemical device is likely to be degraded.

A reason why float property of the electrochemical device is degraded is presumed that internal resistance of the positive electrode increases while the electrochemical device is subjected to float charging. The increase in the internal resistance makes voltage of the electrochemical device decrease so that capacitance of the electrochemical device decreases. This decrease in the capacitance means degradation of float property in the electrochemical device. During the float charging, anions are unevenly gathered in a vicinity of the positive electrode. When the anions react with water that has invaded an inside of the electrochemical device, an acid is generated. This acid deteriorates the carbon layer containing the polymer material as described above. The deterioration of the carbon layer causes the positive current collector to be exposed, so that, for example, the positive current collector is dissolved or melted by the acid, or an oxidized film is formed on a surface of the positive current collector. Thus, internal resistance of the positive electrode is increased. As a result, float property of the electrochemical device would be degraded. Thus, as described above, the polymer material, which has acid resistance, together with the conductive carbon material is incorporated into the carbon layer. However, only using a material having excellent acid resistance as the polymer material would not suppress the degradation of the float property. It is considered that a factor other than the acid resistance of the polymer material would also be related to the degradation of the float property.

In contrast, when a polyolefin resin is incorporated into the carbon layer, degradation of float property in the electrochemical device is suppressed. It is easy to form carbon layer 112 containing a polyolefin resin into a film form that covers the surface of positive current collector 111. In other words, a reason why positive current collector 111 is restrained from being damaged or oxidized in positive electrode 11 having carbon layer 112 would be due to carbon layer 112 formed in a dense state such that this layer hardly has pinholes in addition to the polyolefin resin having acid resistance. It is presumed that by forming carbon layer 112 containing the polyolefin resin, which has acid resistance, in the dense film form, positive current collector 111 is restrained from being exposed during float charging of the electrochemical device. Hence, positive current collector 111 would be restrained from being damaged or oxidized with an acid.

### <<Electrochemical Device>>

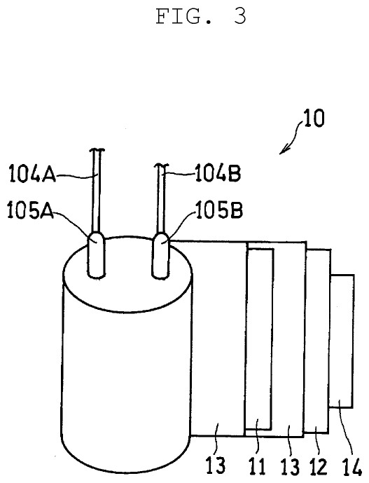

Hereinafter, a configuration of an electrochemical device according to the present invention will be described in more detail with reference to the drawings. FIG. 2 is a schematic sectional view illustrating electrochemical device 100 according to the present exemplary embodiment. FIG. 3 is a schematic developed view illustrating part of electrode group 10 included in electrochemical device 100.

Electrochemical device 100 includes electrode group 10; container 101 which houses electrode group 10; sealing body 102 for sealing an opening in container 101; base plate 103 covering sealing body 102; lead wires 104A and 104B which each lead out from sealing body 102 to penetrate base plate 103; and lead tabs 105A and 105B through which the lead wires are connected to the respective electrodes of electrode group 10. Container 101 is, at a part near an opening end, processed inward by drawing, and is, at the opening end, curled to swage sealing body 102.

### (Positive Current Collector)

For positive current collector 111, for example, a sheet-form metallic material is used. The sheet-form metallic material is, for example, a metal foil, a metal porous body, a punched metal, an expanded metal or an etched metal. As a material for positive current collector 111, for example, aluminum, an aluminum alloy, nickel, titanium and the like can be used. The material is preferably aluminum or an aluminum alloy. Even when positive current collector 111 contains aluminum that has relatively low acid resistance, carbon layer 112 restrains positive current collector 111 from being damaged or oxidized while the electrochemical device is subjected to float charging. Positive current collector 111 has a thickness, for example, ranging from 10 μm to 100 μm, inclusive.

### (Carbon Layer)

Carbon layer 112 is formed, for example, by applying a carbon paste containing a conductive carbon material and a polyolefin resin to a surface of positive current collector 111 to form a coating film, and then drying the coating film. The carbon paste is obtained, for example, by mixing the conductive carbon material, the polyolefin resin, and water or an organic solvent.

As the conductive carbon material, graphite, hard carbon, soft carbon, carbon black and the like can be sued. Among these conductive carbon materials, carbon black is preferable that facilitates formation of carbon layer 112 that is thin and excellent in conductivity. Average diameter D1 of the conductive carbon material is not particularly limited, and ranges, for example, from 3 nm to 500 nm, inclusive, preferably from 10 nm to 100 nm, inclusive. The average particle diameter is a median diameter (D50) in a volume particle size distribution obtained by a laser diffraction particle size distribution measuring apparatus (the same shall apply hereinafter). Average diameter D1 of carbon black may be calculated by an observation through a scanning electron microscope.

Examples of the polyolefin resin include polyethylene resin, polypropylene resin, and ethylene-propylene copolymer. The polyolefin resin is mixed, for example, in a particulate state, with the conductive carbon material. The polyolefin resin may include a unit other than an olefin unit that is derived from a monomer having one or more carbon double bond.

Average particle diameter D2 of the particulate polyolefin resin (hereinafter referred to as polyolefin resin particles) is not particularly limited, and is preferably larger than average particle diameter D1 of the conductive carbon material. Average particle diameter D2 is preferably smaller than a structure length of the conductive carbon material. In this case, the conductive carbon material is restrained from dropping out without impeding conductive property of the conductive carbon materials, and further film-form dense carbon layer 112 is easily formed on positive current collector 111.

In carbon layer 112, a ratio of the polyolefin resin relative to 100 parts by mass of the conductive carbon material is not particularly limited. The ratio ranges, for example, from 20 parts to 300 parts by mass, inclusive, more preferably from 50 parts to 160 parts by mass, inclusive, relative to 100 parts by mass of the conductive carbon material. When the polyolefin resin is contained in a ratio of the above ranges in carbon layer 112, float property of the electrochemical device is improved.

Carbon layer 112 has a thickness ranging preferably from 0.5 μm to 10 μm, inclusive, more preferably from 0.5 μm to 3 μm, inclusive, especially preferably from 0.5 μm to 2 μm, inclusive. The thickness of carbon layer 112 can be obtained by observing a cross section of positive electrode 11 through a scanning electron microscope (SEM), and then calculating an average value of respective thicknesses of any ten sites of this cross section. The thickness of active layer 113 can also be obtained in a similar manner.

In carbon layer 112, it is preferred that a plurality of the polyolefin resin particles are fused to form a particle-joined body. In the particle-joined body, the plurality of the polyolefin resin particles may be fused in a state where shapes of original particles are recognized. It is especially preferred that a particle-joined body with a smooth surface is formed in which the particles are fused to an extend that the shapes of the particles are not kept, while the plurality of the polyolefin resin particles take in the conductive carbon material. In this way, carbon layer 112 is formed easily in a film form. The particle-joined body is formed to cover at least one portion of positive current collector 111. Carbon layer 112 may contain the polyolefin resin in a particulate form. Such a particle-joined body is observable through a cross section of positive electrode 11, using an SEM. The particle-joined body containing the polyolefin resin makes it possible to form carbon layer 112 into a dense film form. Dense carbon layer 112 is also excellent in close adhesiveness to positive current collector 111.

The conductive polymer contained in active layer 113 formed on carbon layer 112 may exhibit a function thereof in a state where electrons are partially lost (oxidized state). Also in this case, carbon layer 112 is restrained from being deteriorated since carbon layer 112 has the polyolefin resin having acid resistance.

### (Active Layer)

Active layer 113 contains a conductive polymer. Active layer 113 is formed, for example, by immersing positive current collector 111 into a reaction liquid containing a raw material monomer for the conductive polymer, and subjecting the raw material monomer to electrolytic polymerization in the presence of positive current collector 111. At this time, positive current collector 111 is used as an anode to conduct the electrolytic polymerization. In this way, active layer 113 containing the conductive polymer is formed to cover a surface of carbon layer 112. A thickness of active layer 113 can be easily controlled by changing, for example, current density in the electrolysis or a period for the polymerization appropriately. The thickness of active layer 113 ranges, for example, from 10 μm to 300 μm, inclusive.

Active layer 113 may be formed by a method other than the electrolytic polymerization. Active layer 113 containing the conductive polymer may be formed, for example, by polymerizing the raw material monomer chemically. Alternatively, active layer 113 may be formed by using a beforehand-prepared conductive polymer, or a dispersion or solution thereof.

The raw material monomer used in the electrolytic polymerization or the chemical polymerization may be a polymerizable compound capable of being polymerized to produce a conductive polymer. The raw material monomer may contain an oligomer. The raw material monomer to be used is aniline, pyrrole, thiophene, furan, thiophene vinylene, pyridine, or a derivative of any one of these monomers. These raw material monomers may be used alone or in combination of two or more of these raw material monomers. The raw material monomer is preferably aniline since this compound allows active layer 113 to be easily formed on the surface of carbon layer 112.

As the conductive polymer, a π-conjugated polymer is preferred. As the π-conjugated polymer, for example, polypyrrole, polythiophene, polyfuran, polyaniline, polythiophene vinylene, polypyridine, or a derivative of any one of these polymers can be sued. These π-conjugated polymers may be used alone or in combination of two or more of these π-conjugated polymers. A weight-average molecular weight of the conductive polymer is not particularly limited, and ranges, for example, from 1000 to 100000, inclusive.

The derivatives of polypyrrole, polythiophene, polyfuran, polyaniline, polythiophene vinylene, and polypyridine mean polymers having, as a basic skeleton, polypyrrole, polythiophene, polyfuran, polyaniline, polythiophene vinylene, and polypyridine, respectively. For example, a polythiophene derivative includes poly(3,4-ethylenedioxythiophene) (PEDOT).

The electrolytic polymerization or the chemical polymerization is preferably performed by use of a reaction liquid containing an anion (dopant). Preferably, the dispersion or solution of the conductive polymer also contains a dopant. The π electron conjugated polymer exhibits excellent conductivity by doping the polymer with a dopant. For example, in the chemical polymerization, positive current collector 111 may be immersed in a reaction liquid containing a dopant, an oxidizing agent, and a raw material monomer, picked out subsequently from the reaction liquid, and dried. In the electrolytic polymerization, positive current collector 111 and a counter electrode may be immersed in a reaction liquid containing a dopant and a raw material monomer; and positive current collector 111 and the counter electrode are used as an anode and a cathode, respectively, to cause an electric current to flow into between the two electrodes.

As a solvent in the reaction liquid, water may be used. A nonaqueous solvent may be used in consideration of solubility of the monomer. As the nonaqueous solvent, alcohols such as ethyl alcohol, methyl alcohol, isopropyl alcohol, ethylene glycol, and propylene glycol can be preferably used. Examples of the dispersing medium or solvent for the conductive polymer include water and these nonaqueous solvents.

Examples of the dopant include a sulfate ion, a nitrate ion, a phosphate ion, a borate ion, a benzenesulfonate ion, a naphthalenesulfonate ion, a toluenesulfonate ion, a methanesulfonate ion (CF₃SO₃⁻), a perchlorate ion (ClO₄⁻), a tetrafluoroborate ion (BF₄⁻), a hexafluorophosphate ion (PF₆⁻), a fluorosulfate ion (FSO₃⁻), a bis(fluorosulfonyl)imide ion (N(FSO₂)₂⁻), and a bis(trifluoromethanesulfonyl)imide ion (N(CF₃SO₂)₂)₂⁻). These dopants may be used alone or in combination of two or more thereof.

The dopant may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamide-2-methylpropanesulfonic acid), polyisoprenesulfonic acid, and polyacrylic acid. These dopants may be a homopolymer or a copolymer of two or more monomers. These dopants may be used alone or in combination of two or more thereof.

The reaction liquid, the dispersion of the conductive polymer, or the solution of the conductive polymer preferably has a pH ranging from 0 to 4 in that the pH makes it easy to form active layer 113. Also when active layer 113 is formed in an acidic atmosphere in this way, carbon layer 112 containing the polyolefin resin is restrained from being deteriorated, so that the conductive property of compound 112 is maintained. Thus, active layer 113 is homogeneously formed on carbon layer 112. Furthermore, the restraint of the deterioration of carbon layer 112 also restrains a corrosion of positive current collector 111. In this way, degradation of float property in the resulting electrochemical device is suppressed.

### (Negative Electrode)

The negative electrode includes, for example, a negative current collector and a negative electrode material layer.

For the negative current collector, for example, a sheet-form metallic material is used. The sheet-form metallic material is, for example, a metal foil, a metal porous body, a punched metal, an expanded metal or an etched metal. As a material for the negative current collector, for example, copper, a copper alloy, nickel, stainless steel and the like can be used.

The negative electrode material layer preferably contains, as a negative electrode active material, a material that electrochemically occludes and releases lithium ions. Examples of such a material include a carbon material, a metal compound, an alloy, and a ceramic material. As the carbon material, graphite, hardly-graphitizable carbon (hard carbon), and easily-graphitizable carbon (soft carbon) are preferable. Graphite and hard carbon are particularly preferable. Examples of the metal compound include silicon oxides and tin oxides. Examples of the alloy include silicon alloys and tin alloys. Examples of the ceramic material include lithium titanate and lithium manganate. These dopants may be used alone or in combination of two or more thereof. Among these materials, the carbon material is preferable in terms of being capable of lowering the negative electrode in potential.

The negative electrode material layer preferably contains, in addition to the negative electrode active material, a conductive agent, a binder and the like. Examples of the conductive agent include carbon black and a carbon fiber. Examples of the binder include a fluororesin, an acrylic resin, a rubber material, and a cellulose derivative. Examples of the fluororesin include polyvinylidene fluoride, polytetrafluoroethylene, and a tetrafluoroethylene-hexafluoropropylene copolymer. Examples of the acrylic resin include polyacrylic acid and an acrylic acid-methacrylic acid copolymer. Examples of the rubber material include a styrene-butadiene rubber, and examples of the cellulose derivative include carboxymethyl cellulose.

The negative electrode material layer is formed, for example, by preparing a negative electrode mixture paste that contains a mixture of a negative electrode active material, a conductive agent, a binder and others with a dispersion medium, applying the negative electrode mixture paste to the negative current collector, followed by drying.

The negative electrode is preferably pre-doped with lithium ions in advance. Thus, potential of the negative electrode is lowered, so that a difference in potential (that is, voltage) between the positive electrode and the negative electrode increases. Consequently, the electrochemical device is improved in energy density.

Pre-doping of the negative electrode with lithium ions is advanced, for example, by forming a metal lithium layer that serves as a supply source of lithium ions on a surface of the negative electrode material layer, and then impregnating the negative electrode having the metal lithium layer with an electrolytic solution (for example, a nonaqueous electrolytic solution) having lithium ion conductivity. At this time, lithium ions are eluted from the metal lithium layer into the nonaqueous electrolytic solution, and the eluted lithium ions are occluded in the negative electrode active material. For example, when graphite or hard carbon is used as the negative electrode active material, lithium ions are inserted into between layers of graphite or into pores in hard carbon. An amount of the lithium ions with which the negative electrode is to be pre-doped can be controlled by the mass of the metal lithium layer.

The step of pre-doping the negative electrode with lithium ions may be performed before the electrode group is assembled, or the pre-doping may be advanced after the electrode group is housed, together with the nonaqueous electrolytic solution, in a case for the electrochemical device.

### (Separator)

As the separator, for example, the following is preferably used: a nonwoven fabric made of cellulose fiber, a nonwoven fabric made of glass fiber, a microporous membrane made of polyolefin, a fabric cloth, or a nonwoven fabric. A thickness of the separator ranges, for example, from 10 μm to 300 μm, inclusive, preferably from 10 μm to 40 μm, inclusive.

### (Electrolytic Solution)

The electrode group preferably impregnates a nonaqueous electrolytic solution.

The nonaqueous electrolytic solution has lithium ion conductivity, and contains a lithium salt and a nonaqueous solvent in which the lithium salt is dissolved. At this time, doping of anions of the lithium salt to the positive electrode and dedoping of the anions from the positive electrode can be reversibly repeated. On the other hand, occlusion of lithium ions derived from the lithium salt into the negative electrode and release of the lithium ions from the negative electrode can be reversibly repeated.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These lithium salts may be used alone or in combination of two or more thereof. Among these lithium salts, at least one selected from the group consisting of lithium salts having an oxo acid anion containing a halogen atom suitable for an anion, and lithium salts having an imide anion is preferably used. A concentration of the lithium salt in the nonaqueous electrolytic solution may range, for example, from 0.2 mol/L to 4 mol/L, inclusive, and is not particularly limited.

As the nonaqueous solvent, cyclic carbonates such as ethylene carbonate, propylene carbonate, and butylene carbonate; chain carbonates such as dimethyl carbonate, diethyl carbonate, and ethyl methyl carbonate; aliphatic carboxylates such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE) and ethoxymethoxyethane (EME); cyclic ethers such as tetrahydrofuran and 2-methyltetrahydrofuran; and dimethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, and 1,3-propanesultone can be used. These solvents may be used alone, or may be used in combination of two or more of these solvents.

In the nonaqueous electrolytic solution, an additive may be added to the nonaqueous solvent as required. For example, an unsaturated carbonate such as vinylene carbonate, vinyl ethylene carbonate or divinyl ethylene carbonate may be added as an additive for forming a film having high lithium ion conductivity on the surface of the negative electrode surface.

### (Production Method)

Hereinafter, one example of the method for producing an electrochemical device according to the present invention will be described with reference to FIGS. 2 and 3. However, the method for producing an electrochemical device according to the present invention is not limited to this example.

Electrochemical device 100 is produced, for example, by a method including steps of applying a carbon paste onto positive current collector 111 to form a coating film, and then drying the coating film to form carbon layer 112; forming active layer 113 containing a conductive polymer onto the carbon layer to yield positive electrode 11; and stacking yielded positive electrode 11, separator 13, and negative electrode 12 in this order. Furthermore, electrode group 10 yielded by stacking positive electrode 11, separator 13, and negative electrode 12 in this order is housed, together with a nonaqueous electrolytic solution, in container 101. The formation of active layer 113 is usually performed in an acidic atmosphere by effect of an oxidizing agent or dopant to be used.

The method for applying the carbon paste onto positive current collector 111 is not particularly limited. Examples thereof include common applying methods such as screen printing, a coating method using any one of various coaters such as a blade coater, a knife coater and a gravure coater, and a spin coating method. The resulting coating film may be dried at a temperature not lower than the melting point of the polyolefin to be used (preferably a temperature of “the melting point of the polyolefin resin”+70° C. or higher, more preferably a temperature of “the melting point of the polyolefin resin”+150° C. to 200° C.) for 5 minutes to 120 minutes. This makes it easy to form dense and film-form carbon layer 112.

As described above, active layer 113 is formed, for example, by subjecting a raw material monomer to electrolytic polymerization or chemical polymerization in the presence of positive current collector 111 having carbon layer 112. Alternatively, the formation is performed by giving a solution containing a conductive polymer or a dispersion of a conductive polymer to positive current collector 111 having carbon layer 112. Also when active layer 113 is formed in an acidic atmosphere, active layer 113 is homogeneously formed since carbon layer 112 having acid resistance is densely formed.

To positive electrode 11 yielded as described above is connected a lead member (lead tab 105A having lead wire 104A). To negative electrode 12 is connected another lead member (lead tab 105B having lead wire 104B). Subsequently, separator 13 is interposed between positive electrode 11 and negative electrode 12, to which these lead members are respectively connected, and then the resulting workpiece is wound to yield electrode group 10 as illustrated in FIG. 3, which has one end surface from which the lead members are exposed. An outermost periphery of electrode group 10 is fixed with fastening tape 14.

Next, as illustrated in FIG. 2, electrode group 10 is housed, together with a nonaqueous electrolytic solution (not illustrated), in bottomed cylindrical container 101 having an opening. Lead wires 104A and 104B are led out from sealing body 102. Sealing body 102 is disposed in the opening in container 101 to seal container 101. Specifically, container 101 is, at a part near an opening end, processed inward by drawing, and is, at the opening end, curled to swage sealing body 102. Sealing body 102 is formed of, for example, an elastic material containing a rubber component.

In the above-mentioned exemplary embodiment, a wound-type electrochemical device having a cylindrical shape has been described. However, the application scope of the present invention is not limited to the wound electrochemical device. Thus, the present invention can also be applied to a rectangular wound-type or a stacked-type electrochemical device.

### EXAMPLES

Hereinafter, the present invention will be described in more detail by way of examples. The present invention, however, is not limited to the examples.

### Example 1

### (1) Preparation of Positive Electrode

An aluminum foil piece having a thickness of 30 μm was prepared as a positive current collector. Meanwhile, an aqueous aniline solution containing aniline and sulfuric acid was prepared.

Water and a mixed powder containing 11 parts by mass of carbon black and 7 parts by mass of polypropylene resin particles were kneaded so that a carbon paste was prepared. The resulting carbon paste was applied onto entire front and rear surfaces of a positive current collector, and then was heated to be dried to form a carbon layer. The carbon layer had a thickness of 2 μm per surface of the positive current collector.

The positive current collector on which the carbon layer was formed, and a counter electrode were immersed in the aqueous aniline solution, and then subjected to electrolytic polymerization at a current density of 10 mA/cm² for 20 minutes. A film of a conductive polymer (polyaniline) doped with sulfate ions (SO₄²⁻) is deposited onto front and rear surfaces of the positive current collector.

The conductive polymer doped with the sulfate ions was reduced to dedope the doped sulfate ions. In this way, an active layer was formed which contained the conductive polymer from which sulfate ions were dedoped. Next, the active layer was sufficiently washed, and then dried. The active layer had a thickness of 35 μm per surface of the positive current collector.

### (2) Preparation of Negative Electrode

A copper foil piece having a thickness of 20 μm was prepared as a negative current collector. Meanwhile, mixed powder containing 97 parts by mass of hard carbon, 1 part by mass of carboxycellulose, and 2 parts by mass of styrene butadiene rubber was kneaded and mixed with water at a ratio by weight of 40:60 to prepare a negative electrode mixture paste. The negative electrode mixture paste was applied to both surfaces of the negative current collector, and dried to yield a negative electrode having, on both surfaces thereof, a negative electrode material layer having a thickness of 35 μm. Next, to the negative electrode material layer was bonded a metal lithium foil in an amount calculated so that a potential of the negative electrode in the electrolytic solution after completion of pre-doping was less than or equal to 0.2 V with respect to a potential of the metal lithium.

### (3) Preparation of Electrode Group

A lead tab was connected to each of the positive electrode and the negative electrode. Thereafter, as illustrated in FIG. 3, a separator of a cellulose nonwoven fabric (thickness of 35 μm), the positive electrode and the negative electrode were stacked to yield a stacked body. The resulting stacked body was wound to form an electrode group.

### (4) Preparation of Nonaqueous Electrolytic Solution

To a mixture of propylene carbonate and dimethyl carbonate at a ratio by volume of 1:1 was added 0.2% by mass of vinylene carbonate to prepare a solvent. LiPF₆ as a lithium salt was dissolved in the resulting solvent at a predetermined concentration to prepare a nonaqueous electrolytic solution containing hexafluorophosphate ions (PF₆⁻) as anions.

### (5) Preparation of Electrochemical Device

The electrode group and the nonaqueous electrolytic solution were housed in a bottomed case having an opening to assemble an electrochemical device as illustrated in FIG. 2. Thereafter, the electrochemical device was aged at 25° C. for 24 hours while a charging voltage of 3.8 V was applied to between terminals of the positive electrode and the negative electrode to advance pre-doping of the negative electrode with lithium ions. The resulting electrochemical device was evaluated in accordance with methods described below.

### (Evaluation Methods)

### (1) Internal Resistance (DCR)

A voltage of 3.8 V was applied to the electrochemical device to charge the electrochemical device, and then the electrochemical device was discharged for a predetermined period. From the amount of a drop of the voltage at this time, an initial internal resistance (initial DCR) of the device was obtained. Table 1 shows the evaluation result.

### (2) Float Property

The resulting electrochemical device was continuously charged at 60° C. and 3.6 V for 1000 hours. At this time, a resistance value of the device was measured to calculate a change ratio of this resistance value to the (initial) resistance before the continuous charging. The change ratio was calculated from “(the resistance value after the charging for the 1000 hours/the initial resistance value)×100”. As the change ratio of the resistance value is smaller, degradation of float property in the electrochemical device is suppressed. Table 1 shows the evaluation result.

### Comparative Example 1

An electrochemical device was produced and evaluated in the same manner as in Example 1 except that carbon black and water glass were mixed to yield a carbon paste. Table 1 shows the evaluation results.

### Comparative Example 2

An electrochemical device was produced and evaluated in the same manner as in Example 1 except that instead of the polypropylene resin particles, a powdery acrylic resin was mixed to yield a carbon paste. Table 1 shows the evaluation results.

### Comparative Example 3

An electrochemical device was produced and evaluated in the same manner as in Example 1 except that instead of the polypropylene resin particles, a powdery SBR was mixed to yield a carbon paste. Table 1 shows the evaluation results.

### Comparative Example 4

An electrochemical device was produced and evaluated in the same manner as in Example 1 except that instead of the polypropylene resin particles, a powdery imide resin was mixed to yield a carbon paste. Table 1 shows the evaluation results.

TABLE 1

| | (1) Initial DCR | (2) Float |
|---|---|---|
| | (mΩ) | property |
| Example 1 | 104 | 135% |
| Comparative Example 1 | 141 | 171% |
| Comparative Example 2 | 167 | 182% |
| Comparative Example 3 | 140 | 160% |
| Comparative Example 4 | 154 | 1000% or more |

### Reference Example

Evaluation samples 1 to 6 having different carbon layer thicknesses (see Table 2) were prepared, and then acid resistances thereof were evaluated. As the carbon layers are higher in acid resistance, degradation of float property in the electrochemical devices is easily suppressed.

The evaluation samples were produced by applying a carbon paste containing carbon black and polypropylene resin particles onto a surface of a positive current collector to form a coating film, and then drying this film. A carbon paste containing no polypropylene resin particles was also prepared. However, this carbon paste was low in wettability to the positive current collector, so that no coating film was able to be formed.

### (Acid Resistance Evaluation)

The evaluation samples were immersed in a 2-M sulfuric acid solution. One of the evaluation samples was used as one electrode, and stainless steel (SUS 316) was used as the other electrode. As a reference electrode, Ag/Ag+ was used to perform 5 cycles in which a step of changing a potential of the sample (vs. Ag/Ag⁺) as follows: −0.5 V→+1.5 V→−0.5 V at 10 mV/s was set as 1 cycle. Thereafter, a measurement was made about a current quantity (leakage current) of the sample at 0.8 V (vs. Ag/Ag⁺). It is demonstrated that as the current quantity is smaller, the positive current collector is restrained from being corroded so that the carbon layer is higher in acid resistance. Table 2 shows the evaluation results.

TABLE 2

| | Carbon layer | Current quantity |
|---|---|---|
| | thickness (μm) | (mA/cm²) |
| Evaluation sample 1 | 0.5 | 0.524 |
| Evaluation sample 2 | 1 | 0.436 |
| Evaluation sample 3 | 2 | 0.420 |
| Evaluation sample 4 | 5 | 0.082 |
| Evaluation sample 5 | 12 | 0.024 |
| Evaluation sample 6 | 20 | 0.020 |

It is understood from Table 2 that even when the carbon layer has a very small thickness of 0.5 μm, the current quantity is sufficiently small, so that the electrochemical device gains an acid resistance effect. Moreover, as the carbon layer becomes larger in thickness, the current quantity becomes smaller. On the other hand, as the carbon layer becomes larger in thickness, internal resistance becomes larger. Hence, from the viewpoint of heightening the acid resistance while restraining an increase in the internal resistance, the thickness of the carbon layer is preferably from 0.5 μm to 20 μm both inclusive (for example, less than or equal to 10 μm), more preferably less than or equal to 5 μm (for example, less than or equal to 3 μm), in particular preferably less than or equal to 2 μm.

### INDUSTRIAL APPLICABILITY

The electrochemical device according to the present invention is excellent in float property, so that it is suitable as various electrochemical devices, in particular, power supplies for backup.

### REFERENCE MARKS IN THE DRAWINGS

10 electrode group
11 positive electrode
12 negative electrode
13 separator
14 fastening tape
100 electrochemical device
101 container
102 sealing body
103 base plate
104A, 104B lead wire
105A, 105B lead tab
111 positive current collector
112 carbon layer
113 active layer

1. An electrochemical device comprising:
a positive electrode;
a negative electrode; and
a separator disposed between the positive electrode and the negative electrode,
wherein:
the positive electrode includes:
a positive current collector;
a carbon layer that is disposed on the positive current collector and includes a conductive carbon material; and
an active layer that is disposed on the carbon layer and includes a conductive polymer; and
the carbon layer includes a polyolefin resin.

2. The electrochemical device according to claim 1, wherein the positive current collector includes aluminum.

3. The electrochemical device according to claim 1, wherein the carbon layer has a thickness ranging from 0.5 μm to 10 μm, inclusive.

4. A method for producing an electrochemical device comprising a positive electrode, a negative electrode, and a separator disposed between the positive electrode and the negative electrode, the method comprising:
forming a carbon layer by applying a carbon paste containing a polyolefin resin onto a positive current collector to form a coating film, and then drying the coating film;
forming an active layer including a conductive polymer onto the carbon layer to yield the positive electrode; and
stacking the positive electrode, the separator, and the negative electrode,
wherein the forming of the active layer is performed in an acidic atmosphere.
